(19) United States
(12) Patent Application Publication
(10) Pub. No.: US 2021/0053484 A1
(43) Pub. Date: Feb. 25, 2021

(54) Emergency Vehicle Safety Bar with Deployable Swing Arm

(71) Applicant: Safer Zone Ltd., Brandon (CA)

(72) Inventor: Garry Paton, Brandon (CA)

(21) Appl. No.: 16/996,176

(22) Filed: Aug. 18, 2020

(30) Foreign Application Priority Data
Aug. 21, 2019 (CA) 3052598

(51) Int. Cl. B60Q 1/26; B60Q 1/52; G09F 21/04

(52) U.S. Cl. CPC B60Q 1/2657; G09F 21/048; B60Q 1/2692; B60Q 1/52

(57) ABSTRACT

Traffic-warning safety bars are provided for emergency or work vehicles to warn oncoming traffic of the presence of emergency or work personnel on or near roadways. One embodiment features an upright elongated support base co-operable with one or move vehicle mounts for height adjustable support of a vertically swinging arm on an upright surface of the vehicle, for example at a gap space or transition found between the driver cabin and rear working section of many emergency vehicles (wreckers, ambulances, fire engines, etc.). In a collapsed position, the swing arm hangs downwardly beside the support base with zero or minimal protrusion from the side of the vehicle. Another embodiment features a roof-mounted support base on which the swing arm is pivotal in a horizontal plane between a stowed position residing entirety within the perimeter boundaries of the vehicle roof, and a deployed position spanning laterally outward therefrom.

### CROSS-REFERENCE TO RELATED APPLICATIONS

This application claims benefit under 35 U.S.C. 119(a) of Canadian Patent Application No 3,052,598, filed Aug. 21, 2019, the entirety of which is incorporated herein by reference.

### FIELD OF THE INVENTION

The present invention relates generally to devices for alerting road traffic to the presence of emergency or work personnel on or near roadways, and more particularly to deployable/retractable devices mountable to emergency or work vehicles for selective lateral deployment therefrom to visually warn traffic of said presence.

### BACKGROUND

Safety devices of the general forgoing type can be seen, for example, in U.S. Pat. No. 10,179,538, in which a safety bar has its swing arm normally stowed flat against the side of a police cruiser in a horizontal orientation and is pivoted ninety degrees about an upright axis by an electric motor to reach laterally out from the vehicle when needed. Another example is found in Published U.S. Patent Application 2017/0210284, in which a deployable alert member is supported with a stationary alert member at the front or rear bumper of a police cruiser and is horizontally deployed out to the side of the vehicle when needed. In Published U.S. Patent Application 2006/0208867, a pair of pivotal swing arms are supported on the roof or rear end of a fire engine, and are pivoted in a vertical plane to their deployed positions when needed. Other examples of safety indicators laterally deployed out to the side of various vehicles types are also known from U.S. Pat. Nos. 4,565,152; 4,825,192; 4,916,372; 6,213,047 and 9,245,465; and Published PCT Application WO2010/110704.

However, there remains room for improved and alternative options in the field of safety bars for emergency and work vehicles whose operating personnel can be regularly exposed to precarious traffic environments.

### SUMMARY OF THE INVENTION

According to a first aspect of the invention, there is provided a safety bar apparatus for a vehicle, said apparatus comprising:

a support base;

a swing arm pivotally coupled to the support base for movement of said swing arm between a collapsed position folded up into adjacency with a side said support base, and a deployed position spanning outwardly from said side of the support base;

one or more vehicle mounts mounted or mountable on said vehicle to carry said support base thereon in a working position from which the swing arm will span laterally out from a side of the vehicle in the deployed position;

wherein the support base and the one or more vehicle mounts are configured to be adjustable in relative position to one another.

According to a second aspect of the invention, there is provided a safety bar apparatus for a vehicle, said apparatus comprising:

a support base;

a swing arm pivotally coupled to the support base for movement of said swing arm between a collapsed position folded up into adjacency with a side said support base, and a deployed position spanning outwardly from said side of the support base;

one or more vehicle mounts mounted or mountable on said vehicle to carry said support base thereon in a working position from which the swing arm will span laterally out from a side of the vehicle in the deployed position;

wherein the support base and the one or more vehicle mounts are configured such that a weight of the support base biases the support base into mated engagement with the one or more vehicle mounts.

According to a third aspect of the invention, there is provided a safety bar apparatus for a vehicle, said apparatus comprising:

a support base;

a swing arm pivotally coupled to the support base for movement of said swing arm between a collapsed position folded up into adjacency with a side said support base, and a deployed position spanning outwardly from said side of the support base;

wherein the support base is equipped with one or more mounting features at a mounting side of the support base, and the swing arm is positioned to respectively reside adjacent to, and span outward from, a different side of the support base in the collapsed and deployed positions, said different side of the support base being of non-opposing relation to said mounting side of the support base.

According to a fourth aspect of the invention, there is provided, in combination, a vehicle and a safety bar apparatus installed thereon, said safety bar apparatus comprising a swing arm pivotally movable on a support base between a collapsed position of zero or minimal protrusive relation from the vehicle, and a deployed position spanning laterally outward from a side of the vehicle to visually warn oncoming traffic of the potential presence of one or more personnel working at or proximate said vehicle, wherein the swing arm is supported on the vehicle by one or more vehicle mounts affixed to the vehicle, and the support base is securable to said one or more vehicle mounts in a plurality of different positions relative thereto to enable repositioning of the swing arm relative to the vehicle.

According to a fifth aspect of the invention, there is provided a safety bar apparatus for a vehicle, said apparatus comprising:

a roof-mountable support base configured for mounting to a roof of said vehicle;

a swing arm pivotally coupled to the support base for pivotal movement of said swing arm relative to said roof-mountable support base about an upright pivot axis between a stowed position projecting laterally from said pivot axis in a first direction so as to span laterally outward from the roof of the vehicle, and a deployed position projecting laterally outward from said pivot axis in a different second direction so as to overlie the roof of the vehicle between opposing longitudinal perimeter edges thereof.

### BRIEF DESCRIPTION OF THE DRAWINGS

Preferred embodiments of the invention will now be described in conjunction with the accompanying drawings in which:

FIG. 1 is a side perspective view of a vertically-swinging, upright-mounted safety bar apparatus according to a first embodiment of the present invention, with a swing arm of the apparatus shown in a deployed position.

FIG. 2 is another side perspective view of the first embodiment apparatus, but from an opposing side thereof.

FIG. 3 is another side perspective view of the first embodiment from the same side as FIG. 1, but with the swing arm shown in a collapsed position.

FIG. 4 is a top plan view of FIG. 1.

FIG. 5 is a top plan view of FIG. 3.

FIG. 6 is a side elevational view of FIG. 1.

FIG. 7 is a side elevational view of FIG. 3.

FIG. 8 is a side elevational view of the apparatus of FIG. 3, but from the opposing side thereof.

FIG. 9 is a side elevational view of FIG. 2.

FIGS. 10 and 11 are front and rear perspective views, respectively, of a flatbed wrecker with the first embodiment apparatus installed thereon, and with the swing arm in the deployed position.

FIGS. 12 to 14 are front, rear and side elevational views, respectively, of the flatbed wrecker of FIGS. 10 and 11, but with the swing arm of the apparatus in the collapsed position.

FIGS. 15 and 16 are front and rear perspective views, respectively, of a fire engine with the first embodiment apparatus installed thereon, and with the swing arm in the deployed position.

FIGS. 17 to 19 are front, rear and side elevational views, respectively, of the fire engine of FIGS. 15 and 16, but with the swing arm of the apparatus in the collapsed position.

FIGS. 20 and 21 are front and rear perspective views, respectively, of an ambulance with the first embodiment apparatus installed thereon, and with the swing arm in the deployed position.

FIGS. 22 to 24 are front, rear and side elevational views, respectively, of the ambulance of FIGS. 20 and 21, but with the swing arm of the apparatus in the collapsed position.

FIGS. 25 and 26 are rear and front elevational views of a horizontally swinging, roof mountable safety bar apparatus according to a second embodiment of the present invention, with a swing arm thereof shown in a deployed position.

FIG. 27 is a top plan view of the safety bar apparatus of FIGS. 25 and 26.

FIG. 28 is a top plan view of the safety bar apparatus of FIGS. 25 to 27, but with the swing arm thereof shown in a stowed position.

FIG. 29 is a perspective view of the safety bar apparatus of FIGS. 25 to 27.

FIG. 30 is a side elevational view of a police cruiser on which a roof-mountable safety bar apparatus similar to that of FIGS. 25 to 29 has been installed, with the swing arm shown in the stowed position.

FIG. 31 is another side elevational view of the police cruiser of FIG. 30, but with the swing arm of the apparatus shown in the deployed position.

FIG. 32 is a front view of the police cruiser of FIG. 31.

FIG. 33 is a rear review of the police cruiser of FIG. 30.

FIGS. 34 and 35 are front and rear perspective views of another police cruiser equipped with a variant of the second embodiment in which the stowed and deployed positions of the swing arm reside at 180-degrees, rather than 90-degrees, to one another.

### DETAILED DESCRIPTION

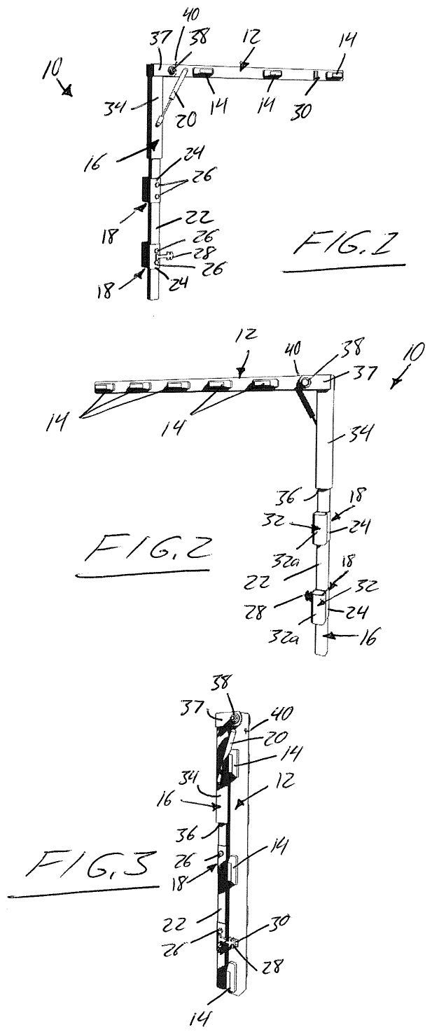

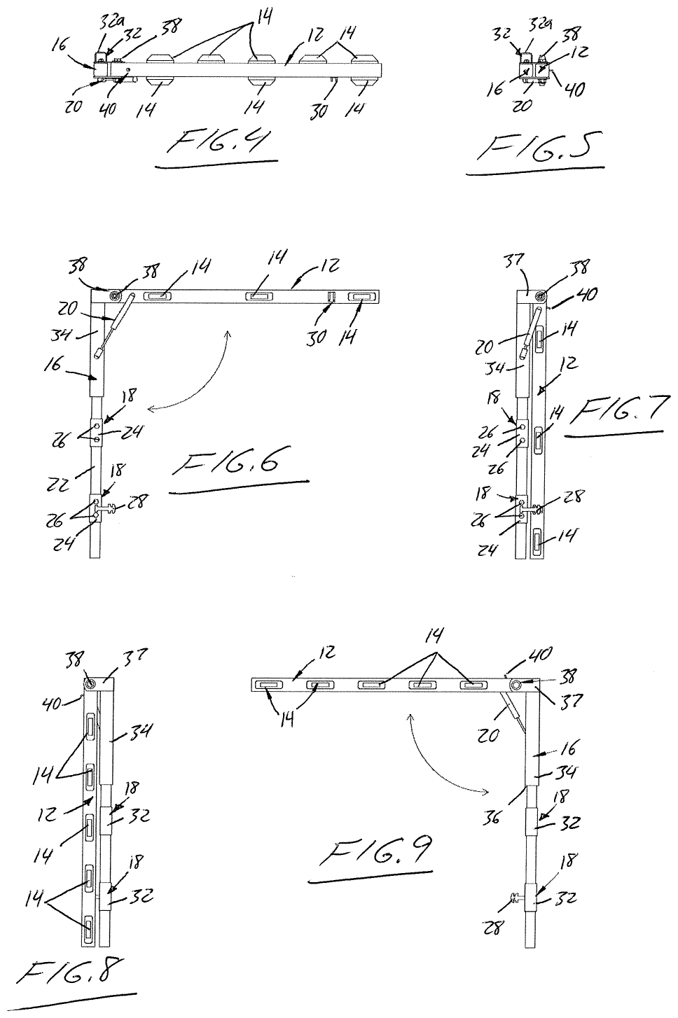

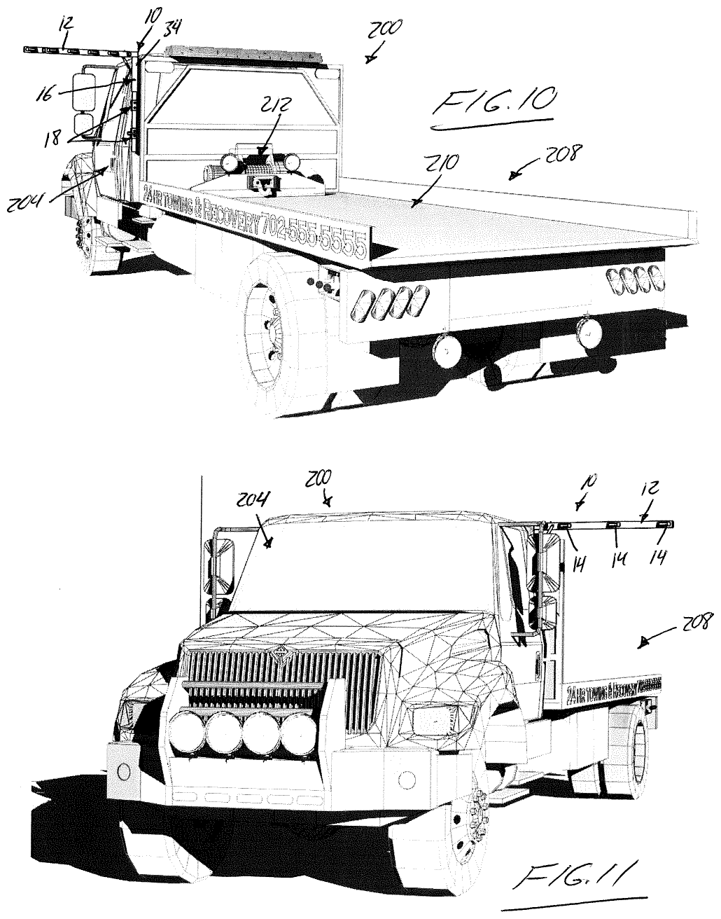

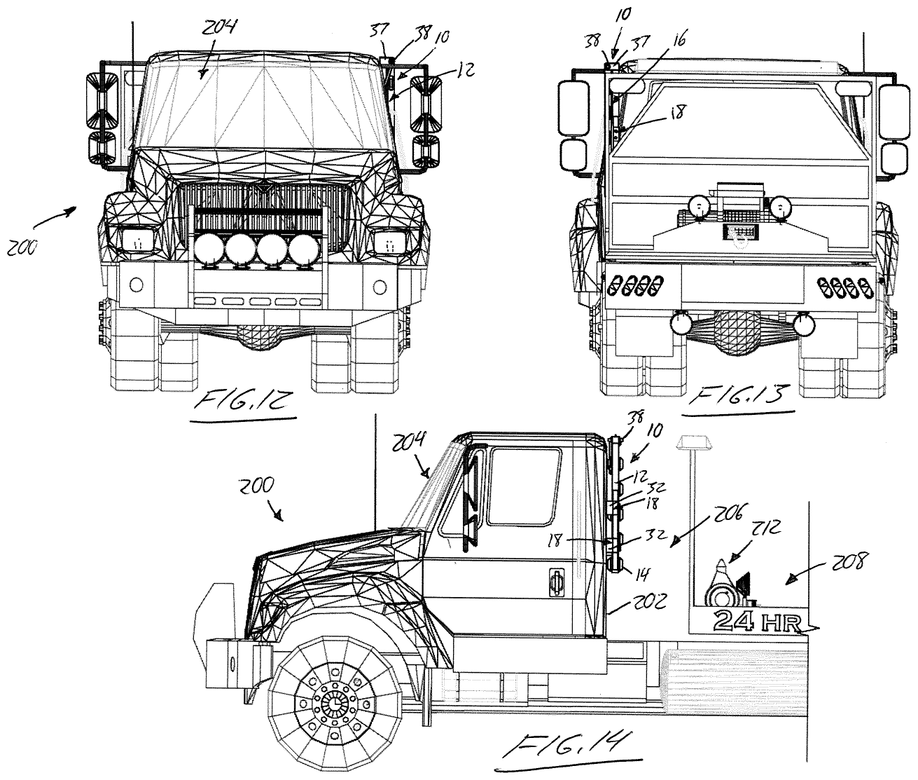

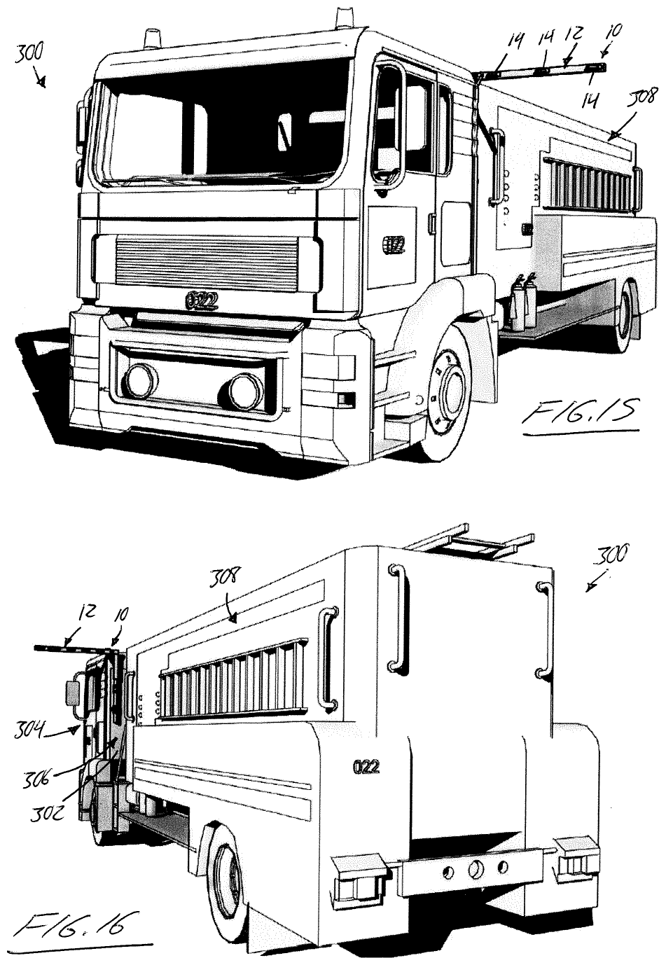

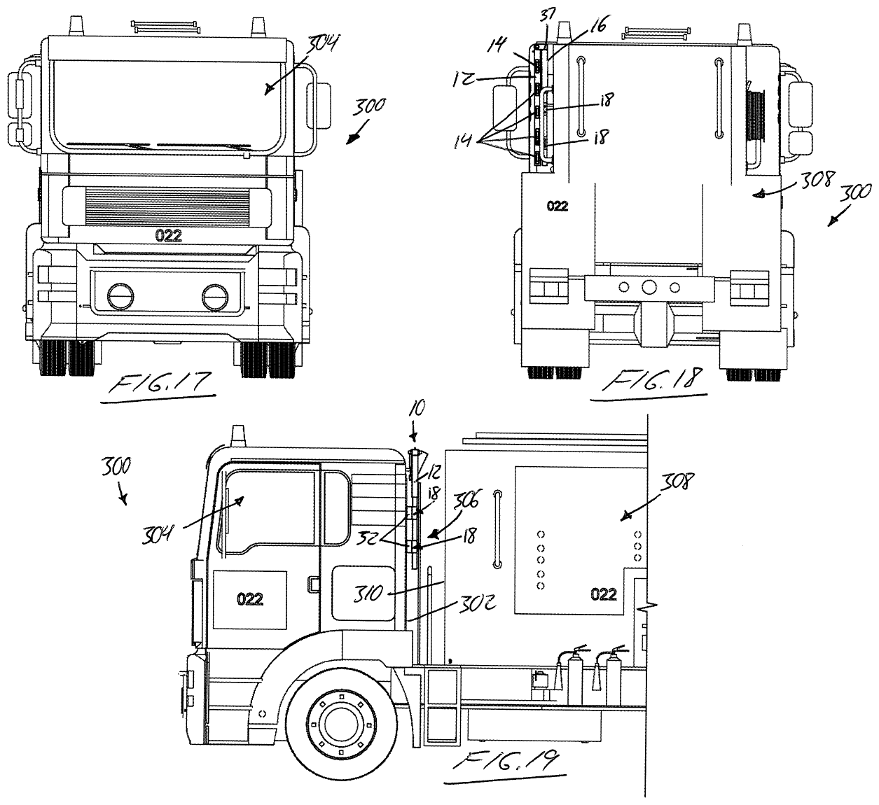

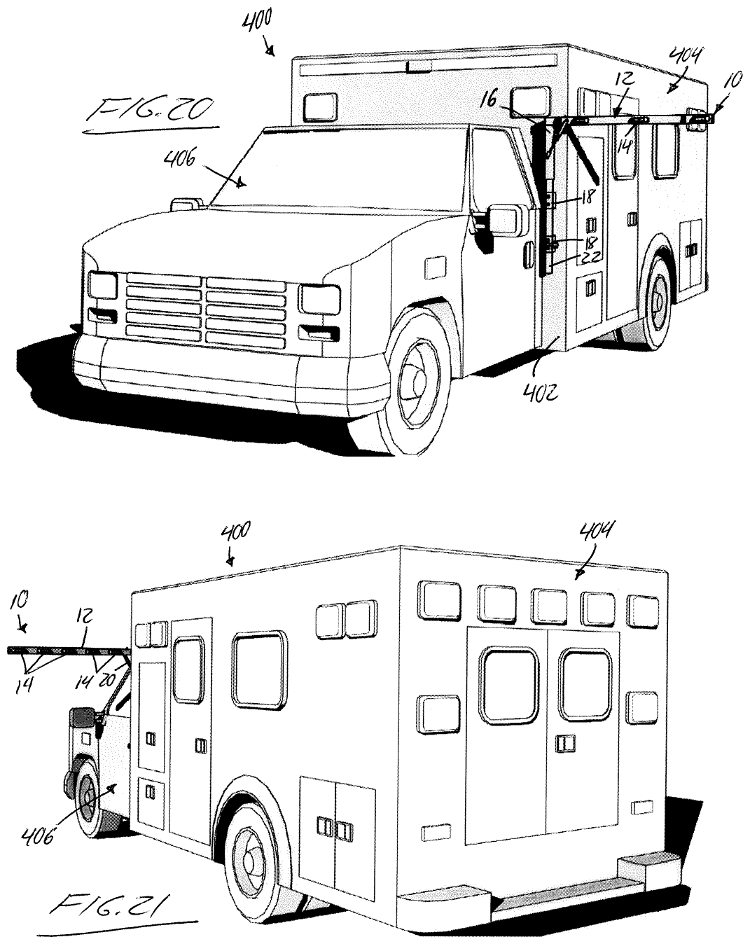

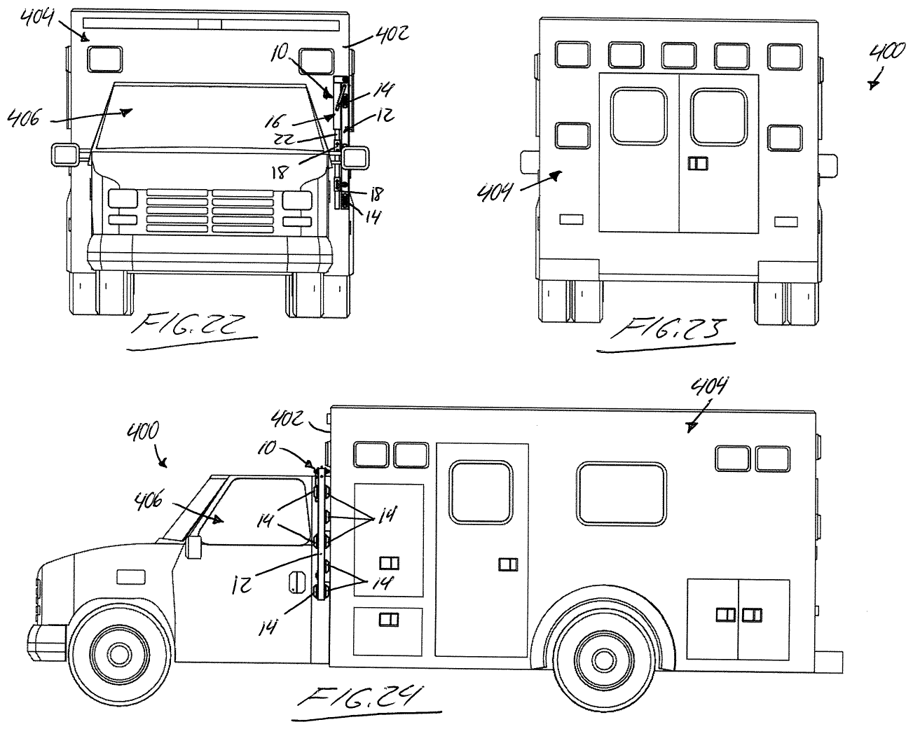

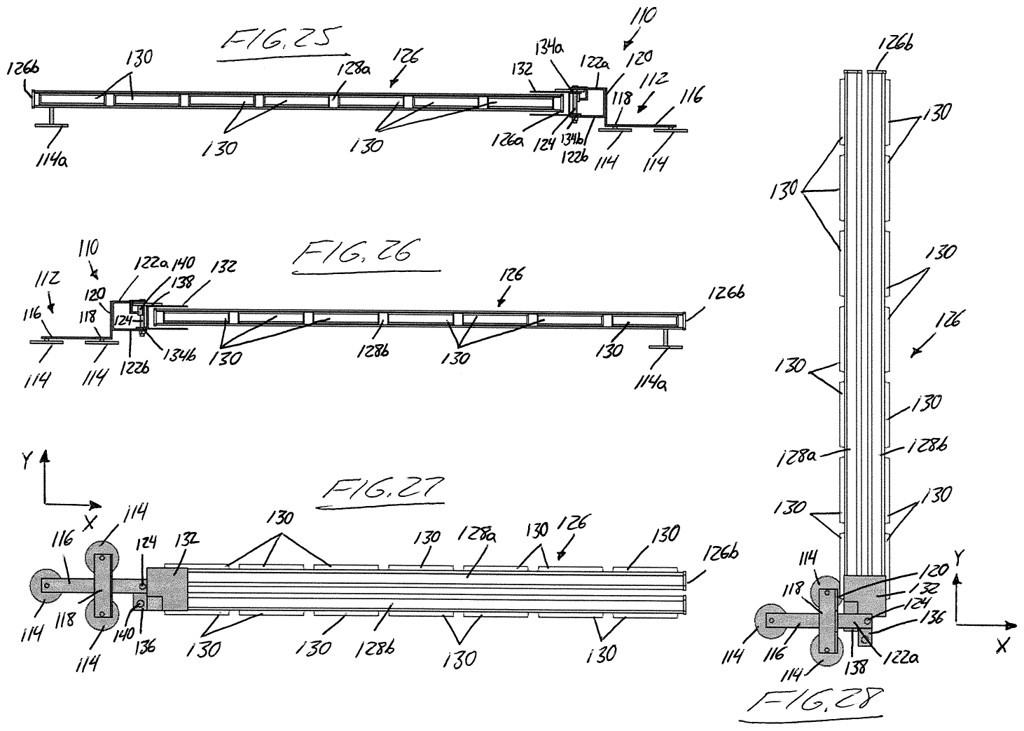

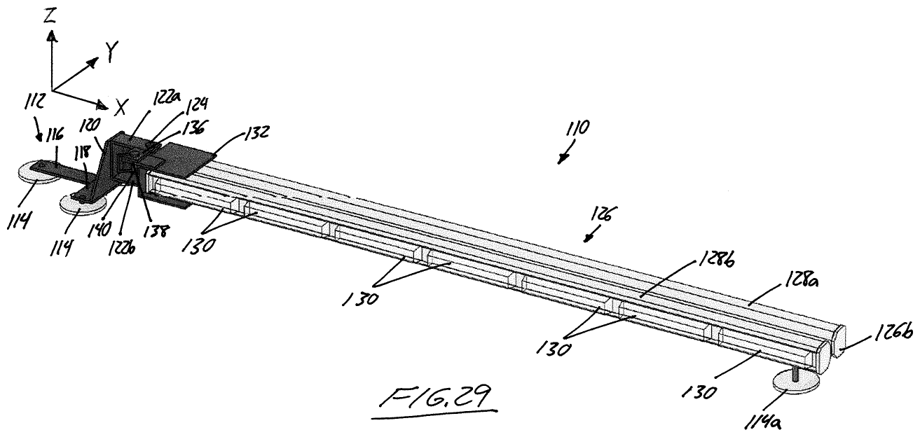

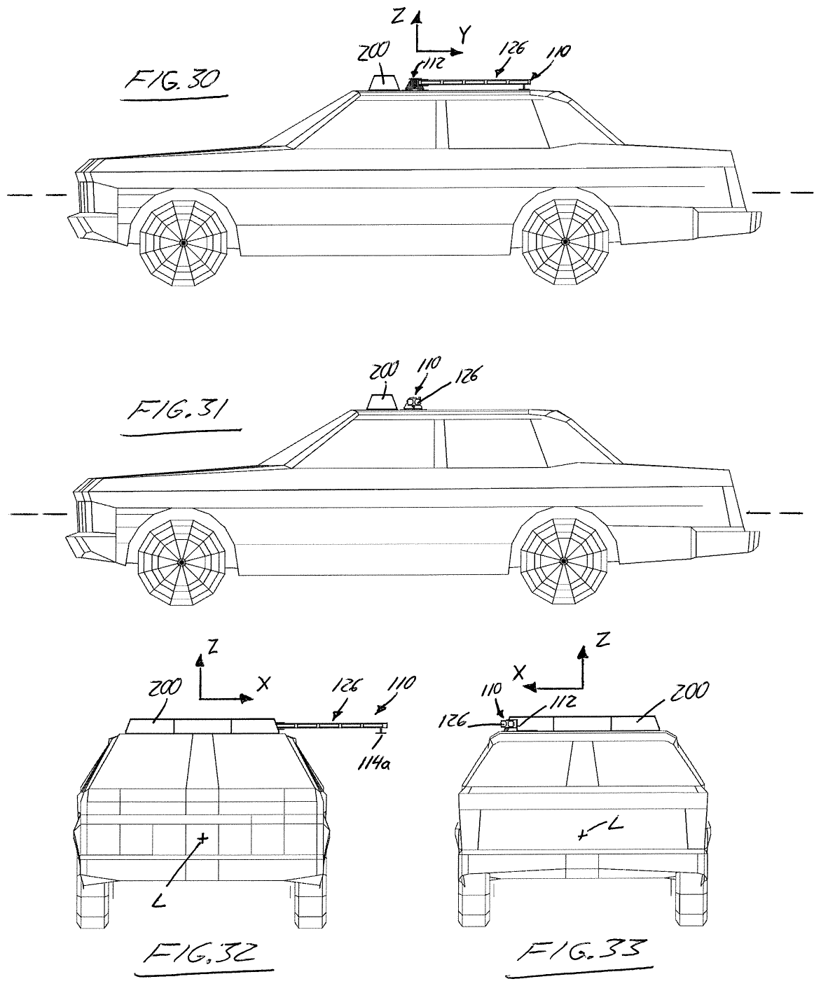

FIGS. 1 through 9 illustrate a safety bar apparatus 10 according to a first embodiment of the present invention, the primary components of which comprise a swing arm 12 equipped with a set of warning lights 14 thereon, an elongated upright support base 16 on which the swing arm 12 is pivotally carried, a pair of repositionable vehicle mounts 18 adjustably and removably coupled to the support base 16, and an actuator 20 operable to effective pivotal movement of the swing arm from a collapsed position hanging alongside the support base 16 in closely adjacent and generally vertical parallel relation thereto, and a deployed position reaching laterally outward from the support base to one side thereof in generally horizontal and perpendicular relation thereto. FIGS. 3, 5, 7 and 8 show the swing arm while stowed in the collapsed position, and FIGS. 1, 2, 4, 6 and 9 show the swing arm in the deployed position.

In the illustrated embodiment, the elongated support base 16 comprises a lower shank 22 of square cross-section, and each vehicle mount comprises a cross-sectionally square collar 24 that spans circumferentially around the shank 22. The collar 24 of each mount 18 is slidable up and down the shank 22 to adjust an elevational height on the support base 16 at which the mount 18 resides. In the illustrated embodiment, the lower shank 22 is defined by a length of square metal tubing, and the slidable collar of each vehicle mount also comprises a respective piece of square metal tubing, but of shorter axial length and larger cross-sectional size than that of the shank 22. Accordingly, the hollow interior of each collar 24 is of slightly greater cross-sectional size than the outer cross-sectional size of the shank 22, thereby allowing the relative sliding of the shank 22 back and forth through the collars 24 of the vehicle mounts 18 to adjust the relative positioning between the support base and the vehicle mounts in the upright axial direction of the support base 16.

At least one locking element is provided on each vehicle mount for locking thereof at a selected position along the shank 22 of the support base. In the illustrated embodiment, two threaded bolts 26 engage through a pair of threaded bores in one side of the rectangular tubing of each collar 24 for selective tightening of the bolts 26 against the shank in set-screw fashion to serve as the locking elements operable to lock the vehicle mount and the support base at a selected relative position one another anywhere along the lower shank 22. A lower one of the two vehicle mounts 18 situated nearer the bottom end of the support base 16 also features a latching member 28 for selective coupling with a corresponding catch member 30 mounted on the swing arm when the arm is in the collapsed position, as can be seen in FIGS. 3 and 7. In the illustrated example, the latching member 28 is a resilient plastic latching member having an elongated stem spanning laterally from the lower vehicle mount to the same side thereof at which the swing arm resides when collapsed, and one or more enlargements carried at the distal end of the stem. The catch member 30 comprises a jaw into which the stem of the latching member 28 can be snapped through an open mouth of the jaw, whereupon the distal enlargement of the latching member blocks retraction of the latching member through the jaw to lock the swing arm against pivotal movement, and the snap-fit of the stem through the mouth of the jaw prevents the latching member from being inadvertently withdrawn through the open mouth of the jaw. Such latches are known and commercially available, and thus no described herein in further detail. Alternative forms of latch or coupler may be used to selectively secure the swing arm in the collapsed position.

The latch is particularly useful in the illustrated embodiment, where the actuator 20 is a gas spring that automatically biases the swing arm into the deployed position, hence the use of a latching mechanism to secure the arm in the collapsed position when not in use. Use of a gas spring avoids the need for an external power source (whether electric, hydraulic or pneumatic), and thereby lends simplicity and cost efficiency. However, other embodiments may alternatively employ powered actuators, in which case connection to an existing electrical, hydraulic or pneumatic system of the vehicle may preferably be used. In yet another embodiment, the actuator may be omitted altogether, with reliance instead made on manual deployment of the swing arm when needed, provided a suitable latch or other securement is provided to hold the swing arm in the deployed position after such manual deployment thereof.

In addition to the sliding collar 24 movable along the shank of the support base, each vehicle mount 18 also features a mounting body 32 affixed to the sliding collar 24 on a side of the support base other than that at which the swing arm resides. More specifically, the side of the support base 16 at which the mounting bodies 32 of the vehicle mounts 18 reside is not only different from the side at which the swing arm resides, but is also of non-opposing relation to that side. Accordingly, using the longitudinal axis of the elongated support base as a reference, the location of the mounting bodies 32 is offset ninety-degrees around this axis from the swing arm 12. The mounting body 32 refers to the part of the vehicle mount 18 that is welded, bolted or otherwise affixed to a vehicle to install the safety bar thereon. In the illustrated embodiment, the mounting body 32 comprises another short piece of rectangular tubing affixed to the slidable collar 24 in parallel and adjacent relation thereto, for example by welding.

The outer side 32a of the mounting body furthest from the slidable collar 24 thus forms a surface for placement against a vehicle surface to enable welded, bolted or other attachment of the vehicle mount 18 to the vehicle. The distance by which the vertical plane of this outer side 32a of the mounting body is spaced from a vertical reference plane occupied by the nearest side of the shank 22 exceeds the distance by which any component of the swing arm 12 (including the optionally-protruding warning lights 14 thereof) is spaced in the same direction from that reference plane. The mounting bodies create a clearance space between the vehicle surface and the support base to accommodate movement of the arm between the collapsed and deployed positions in a generally vertical swinging plane parallel to the vehicle surface to which the support base 16 is mounted. Such installed positions are described herein further below with reference to later figures showing the safety bar on a selection of various emergency vehicles. The mounting body 32 resides at a side of the collar 24 other than that at which the locking elements 26 reside, and in the illustrated example, more specifically resides at the side of the collar 24 opposite the locking elements 26 to enable convenient access to the locking elements 26 in the installed positions of the mounts 18 on the vehicle, though the particular placement of the locking elements may vary from this preferred lkayout.

Above the shank 22, the elongated support base 16 features a widened upper portion 34, for example created by another length of square tubing fitted whose cross-sectional size exceeds that of the shank 22, whereby this larger piece of tubing is fitted and affixed externally over the upper end of the shank 22. For example, this widened upper portion 34 may comprise tubing of the same cross-sectional size as the mount collars 24 and mounting bodies 32. The difference in width between the lower shank 22 and wider supper portion 34 creates a downward facing shoulder 36 that obstructs relative upward sliding of the collars 24 of the vehicle mounts 18 past this shoulder 36. Accordingly, when the vehicle mounts 18 are affixed to a vehicle, the shoulder 36 acts as a stop feature limiting how far the support base 16 can be lowered downwardly through the collars 24 of the vehicle mounts 18 due to contact of the shoulder 36 with the collar of the upper vehicle mount. This contact between the stop shoulder 36 and the collar of the upper vehicle mount therefore defines the lowermost position at which the support base 16 can be set on the vehicle once the vehicle mounts 18 have been affixed in place at selected positions on the selected surface of the vehicle. At the top end of the support base 16, a pair of support lugs 37 project perpendicularly out from therefrom to the side thereof at which the swing arm 12 resides. A proximal end of the swing arm 12 is received between these lugs 37 to enable pivotal support of the swing arm 12 by way of a pivot pin 38 passed horizontally through the lugs 37 and the end-adjacent portion of the swing arm received therebetween. A lower end of the actuator 20 is pivotally coupled to the wider upper portion 34 of the support base 36 so as to reside at an intermediate elevation between the stop shoulder 36 and the pivot support lugs 37. The actuator 20 therefore resides above the stop shoulder 36, whereby upper vehicle mount can never reach a position impacting or interfering with the actuator 20.

By installing the vehicle mounts 18 on a vehicle in aligned upright positions in which the axes of the mount collars 24 lie coincident with one another in a generally vertical orientation, and by having an elongated support base 16 with a shank 22 slidably receivable in the mount collars 24, and a stop shoulder 36 limiting downward sliding of the support base 16 through the vehicle-mounted collars 24, selective placement, adjustment and removal of the support base and attached swing arm on the vehicle is easily performed. Installation requires only sufficient loosening of the locking elements 26 on the vehicle mounts 18 to allow the insertion of the support base shank 22 downwardly through the collar of the upper vehicle mount and into the aligned collar of the lower vehicle mount, thereby achieving mated engagement of the support base 16 with both mounts 18. This engaged state is automatically maintained on a gravitational basis, as the weight of the support base 16 and the attached swing arm 12 biases the support base 16 downwardly, thus maintaining the shanks 22 mated position inside the mount collars 24.

Provided that that the vehicle mounts 18 are installed at relative elevations at which the top-to-top distance between the two mounts 18 doesn't exceed the axial measure of the shank 22 from the stop shoulder 36 to the bottom end of the shank 22, the height of the support base on the vehicle can be adjusted by pulling the shank 22 upward from its lowermost position (in which the stop shoulder 36 rests on the top vehicle mount) to a more elevated position, followed by tightening of the locking elements 26 to secure the support base 16 in this selected, more-elevated position. This adjustment of the support base's elevational position on the vehicle the can be used to set the particular working height of the swing arm 12 on the vehicle. As a result, the height at which the swing arm resides on the vehicle is not dictated purely on the availability of a suitable mounting space at a specific height on the vehicle. The customer or installer therefore has optimal flexibility in terms of selecting suitable mounting spaces on the vehicle and a suitable working height for the swing arm.

While the illustrated embodiment features two separate vehicle mounts 18, other embodiments may employ only a singular vehicle mount that is likewise adjustable its relative longitudinal position along the support base to enable height adjustment of the support base and attached swing arm. While the illustrated embodiment employs square tubing at the support base and vehicle mounts to accomplish relative sliding therebetween on a longitudinal axis, while the straight-sided cross-sectional shape of the tubing prevents relative rotation of the support base and vehicle mounts about said longitudinal axis, it will be appreciated that the other slidably matable, rotation-preventing shapes or profiles may be used.

FIGS. 10 to 14 illustrate numerous applications for the forgoing embodiment of the safety bar 10, which is particularly useful for emergency vehicles and work vehicles that often need to park on or adjacent busy roadways to attend to emergency situations, and where access to and from the vehicle introduces risk to the emergency or working personnel. As shown, the preferred embodiment is an illuminable safety bar having warning lights 14 on the swing arm thereof, preferably operable in a flashing state for maximum visual effectiveness, but it will be appreciated that non-illuminating alternatives (for example, instead equipped only reflective indicia) may still benefit from the other advantageous features disclosed herein. A wiring harness for connecting the lights 14 to an existing power supply of the vehicle is included as part of the apparatus, but is omitted for illustrative simplicity in the drawings, though an on/off switch 40 is shown on the swing arm 12 near the proximal end thereof on the side of the arm that faces upwardly in the deployed position and laterally away from the base in the collapsed position. As an alternative to connection to the vehicle's electrical system for power, the apparatus may incorporate a dedicated power source, for example its own battery pack, which may be rechargeable, and optionally an accompanying solar panel for automatic charging.

FIGS. 10 through 14 show the safety bar 10 installed on a flatbed wrecker 200, and more specifically mounted the rear wall 202 of the driver cabin 204 of the flatbed wrecker 200, whereby the safety bar 10 resides in a gap space 206 between the driver cabin and the separate rear working section 208 of the vehicle, which in the case of a flatbed wrecker is occupied by the flatbed platform 210 and associated loading winch 212 used to load and transport a wrecked vehicle. The two vehicle mounts 18 are welded, bolted or otherwise attached to the rear cabin wall 202 of the vehicle in vertically spaced positions aligned one over the other near a respective outer side of the rear cabin wall 202 so that the swing arm reaches laterally outward from the respective side of the vehicle when deployed.

The illustrated example shows one safety bar installed at the driver's side of the cabin 204, thus being most useful in a common scenario where the wrecker is parked facing the same direction as traffic flow on the right side of the roadway, thereby placing the driver's side door of the vehicle in hazardous adjacency to passing traffic. However, it will be appreciated that a second matching safety bar 10 may be installed at the passenger side of the driver's cabin, or a second set of vehicle mounts 18 may be mounted at the passenger side of the operator cabin, allowing the driver to selectively move the support base 16 and connected swing arm 12 from one side of the vehicle to the other according to a particular scenario in which the apparatus is needed to warn traffic.

As shown in the front and rear views of FIGS. 12 and 13, no portion of the apparatus 10 resides laterally outboard of the vehicle itself when the swing arm is in the collapsed position, in which the visibility of the apparatus is also substantially obstructed from the front and rear by the driver cabin and the upright wall or frame at the front end of the flatbed. As shown in FIG. 14, even in a side elevational view, the vertically oriented support base 16 and the collapsed swing arm hanging vertically therebeside occupy minimal visual space, thus substantially maintaining the original vehicle aesthetic when the swing arm is stowed between uses.

FIGS. 15 through 19 show the safety bar 10 similarly installed on a fire engine 300 at the rear wall 302 of the driver cabin 304 to likewise reside in a gap space 306 between the driver cabin and the separate rear working section 308 of the fire engine at which various firefighting equipment is installed or stored. Alternatively, the safety bar 10 may also be supported in this gap space by installation of the vehicle mounts at a forward-facing upright wall somewhere on the rear working section of the fire engine, for example at a front forward-facing wall 310 thereof facing the driver cabin, depending on the particular fire engine design. The safety bar 10, when collapsed, again has zero lateral protrusion from the vehicle, and in the illustrated example is entirety unseen from the front of the vehicle when collapsed. Once again, safety bar has minimal visual exposure from the rear and side of the vehicle, when collapsed.

FIGS. 20 through 24 show the safety bar 10 similarly installed on an ambulance 400, in this case on the front wall 402 of the rear patient cabin 404, which denotes a transitional area between the rear patient cabin where the emergency medical personnel perform their work on the patient, and the front driver cabin 406. Typically, the rear patient cabin 404 is wider than the driver cabin, hence the presence of an outer margin space on the front wall 402 of the patient cabin that projects laterally outward beyond the respective side of the driver cabin, and thus being suitable as a mounting site for the safety bar 10, as shown in the drawings. So rather than being mounted in a gap space between a front driver cabin and rear working section of the vehicle, like with the wrecker and fire engine examples shown in the earlier figures, the safety bar is instead mounted on an upright wall facing the forward travel direction of the vehicle at a transitional area between a wider rear working section of the vehicle and a narrower front driver cabin. As shown in FIGS. 22 and 23, the safety bar, when collapsed, once again has zero lateral projection from the outermost side of the vehicle, and in the illustrated case is entirety unseen from the rear of the vehicle. As shown in FIG. 24, the safety bar once again occupies minimal visual space even in the side elevational view, thus substantially maintaining the original vehicle aesthetic when the swing arm is stowed.

FIGS. 25 to 29 illustrated a second embodiment safety bar apparatus 110 configured for roof-mounted installation on an emergency or work vehicle, for example such as the police cruiser shown in FIGS. 30 to 33. The apparatus 110 features a roof-mountable support base 112 configured at the underside thereof for attachment to the roof of a vehicle. In the illustrated embodiment, this is achieved by way of a set of magnetic feet 114 each comprising a permanent magnet embedded within a surrounding envelope of resilient rubber material, thereby forming a protective cover to prevent marring of the vehicle roof during placement of the apparatus thereon. The magnetic feet cooperatively form a magnetic mounting mechanism for securing the support base to the roof of the vehicle in a releasable manner enabling simple tool-free installation and removal. Magnetic mounting of the support base on the vehicle is merely one installation option however, and other attachment techniques, for example permanently welded attachment or permanent or removably fastened attachment using bolts or other suitable fasteners may alternatively be employed. The illustrated embodiment employs a set of three magnetic feet 114 mounted at terminal points of a T-shaped support base formed by a main bar 116 lying in a horizontal X-direction, and a cross-bar 118 lying perpendicular to the main bar 116 in a horizontal Y-direction. Two of the magnetic feet 114 are mounted to the underside of the cross-bar 118 at the opposing ends thereof on opposite sides of the main bar 116, and the third magnetic foot is mounted at a distal end 116a of the main bar furthest from the cross-bar. While use of three magnetic feet at spaced apart positions in a two dimensional bottom plane of the support base at respective corners of a triangular area provides notable stability, the quantity and layout of magnetic feet may vary.

Along the edge of the cross-bar 118 that lies opposite the main bar 116, the base features an upright support plate 120 standing vertically upward in perpendicular relation to the horizontal planes occupied by the main bar 116 and cross bar 118. The 112 base also features a pair of lugs 122a, 122b projecting from the support plate 120 respective near the top and bottom ends thereof so as to respectively reside in vertically-spaced horizontal planes. A pair of aligned pin apertures penetrate vertically through the lugs 122a, 122b to accommodate passage of a pivot pin 124 vertically therethrough. The swing arm 126 in this embodiment pivots in a horizontal plane about the vertical axis of this pivot pin 124. In the illustrated example, the swing arm 126 is formed by a pair of parallel light bars 128a, 128b each having a respective set of warning lights 130 on one side thereof to face outward from a respective side of the swing arm 126, but particular the construction of the swing arm may vary. The swing arm 126, at a proximal end 126a thereof nearest the support base, features a support bracket 132 that holds together the two light bars 128a, 128b, and that is used to establish the pivotal connection to the support base via the pivot pin 124. On an outer side of the bracket facing the light bars, the bracket 132 is channel-shaped to embrace over and under the proximal ends of the light bars 128a, 128b. On its opposing inner, the end bracket 132 features a vertically-spaced, horizontal coupling flanges 134a, 134b that lie between the lugs 122a, 122b of the support base in parallel relation thereto, and that likewise have aligned pin apertures therein for alignment with those in the support base lugs. The pivot pin 124 thus spans through the lugs 122a, 122b and the coupling flanges 134a, 134b to pivotally couple the end bracket 132 of the swing arm 126 to the support base 112.

The support base 112 features a lateral extension 136 that reaches horizontally out to one side of the top lug 122a thereof in the Y-direction, and features a lock pin hole penetrating vertically therethrough. The end bracket 132 of the swing arm features an inner extension 138 that resides beside the upper coupling flange 134a and has a second lock pin hole therein that aligns with the lock pin hole of the support base extension 136 when the swing arm 126 is in a deployed position lying in the X-direction, as shown in FIGS. 25 to 27 and 29. Accordingly, when the swing arm is deployed, a lock pin 140 can be engaged through the lock pin holes of the swing arm and support base extensions to lock the swing arm in this deployed position. When the lock pin 140 is removed, the swing arm is free to swing horizontally out of the deployed position into a stowed position lying the Y-direction, as shown in FIG. 28.

The illustrated embodiment not only uses magnetic attraction for selective, removable mounting of the support base 112 to the roof of a vehicle, but also uses magnetic attraction with the vehicle roof to secure the swing arm 126 in the stowed position. For such purposes, a magnetic securement mechanism is provided in the form of an additional magnetic foot 114a of the same type described above for the support base, but mounted to the underside of the swing arm 126 at or adjacent the distal end 126b thereof furthest from the support base 112.

FIGS. 30 to 33 demonstrate installation and use of the roof mounted embodiment on the roof of a police cruiser, and show a slightly shorter variant of the apparatus in order to fit within the size constraints of a particular rooftop scenario. The support base 112 is mounted atop the roof, in removable magnetic fashion in the case of the illustrated embodiment, at a location proximate, but spaced inwardly from, a respective longitudinal perimeter edge the roof. In the illustrated example, the support base 112 is placed near the left (i.e. driver's side) longitudinal perimeter edge of the roof. The support base is oriented such that the X-direction of the apparatus lies cross-wise to the vehicle, and the Y-direction of the apparatus lies longitudinally of the vehicle. This way, as shown in FIG. 30, when the swing arm 126 is in the stowed position, it lies longitudinally of the vehicle (generally parallel to longitudinal vehicle axis L, which denotes the longitudinal direction in which the front and rear ends of the vehicle are spaced and in which vehicle travels when driven). In the illustrated example, the support base is placed closely behind a rooftop emergency lightbar 200 of the police cruiser, and so the stowed position of the swing arm 126 specifically spans rearwardly from the support base 112 toward the rear end of the vehicle. The support base 112 could alternatively be mounted near a rear corner of the roof further behind the emergency lightbar 200 so as to span forwardly from the support base 112 in the stowed position, provided enough clearance space was left between the emergency lightbar 200 and the support base to accommodate the stowed swing arm therebetween.

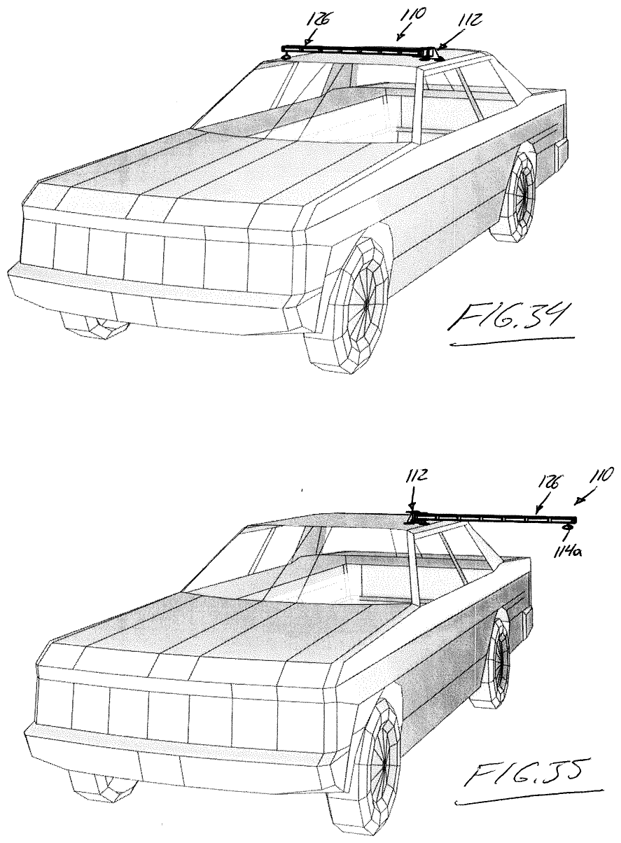

The support base 112 is placed at a location spaced inwardly from the respective longitudinal perimeter edge of the roof by a sufficient amount so that the distance from the upright support plate 20 to the longitudinal perimeter edge of the roof exceeds the width of the swing arm 126. This way, in the stowed position, the swing arm 126 lies entirely within the footprint of the vehicle roof, spanning longitudinally thereover in close adjacency to the respective longitudinal perimeter edge of the roof, without any portion of the apparatus residing outwardly therepast. This can best be seen in FIG. 33, where the entirety of the stowed swing arm 126 resides in direct overhead relation to the vehicle roof within the four perimeter boundaries thereof, with no protruding features residing outwardly therefrom. The swing arm 126 is normally retained in the stowed position by magnetic attraction of the magnetic securement foot 114a on the distal end 126b of the swing arm 126 to the underlying roof of the vehicle. Optionally, the magnetic securement foot 114a may be moved further toward the proximal end of the swing arm to a more intermediate location thereon, for example if a longer swing arm is used that extends rearwardly past the rear perimeter edge of the roof when stowed. Such magnetic securement to the roof is only one non-limiting example of possible securement arrangements for the stowed position. For example, a receiving bracket could be mounted to the vehicle roof at a longitudinally spaced location from the support base 112, for example near the rear corner of the roof on the same side of the vehicle, to receive a portion of the swing arm in the stowed position thereof. Such receiving bracket may be equipped with suitable securement features to hold the swing arm in this position, whether by magnetic attraction or mechanical lock or coupling.

FIG. 32 shows the swing arm 126 in the deployed position, reaching laterally outward from the roof of the vehicle at the longitudinal perimeter side thereof along which the swing arm normally resides in the stowed position. The lock pin 140 enables the user to lock the arm 126 in the deployed position once manually swung out from the stowed position with sufficient force to overcome the magnetic attraction between the vehicle roof and the magnetic securement foot 114a, if such magnetic securement is employed. Locking the arm in the deployed position prevents it from inadvertently swinging therefrom, as otherwise might occur, for example during windy environmental conditions. It will be appreciated that locking means other than a selectively insertable and removable lock pin 140 may alternatively be employed to hold the swing arm in the deployed position.

In the illustrated example, the lock pin holes are positioned to align when the swing arm lies in the X-direction, thereby denoting that the lockable deployed position resides at ninety-degrees to the stowed position, thus stowing the swing arm in a longitudinally oriented relation to the vehicle along a respective longitudinal perimeter edge of the vehicle roof. In other instances, where the position of the lightbar 200, beacon or other emergency lighting equipment of the vehicle roof and relative size of the roof may prohibit longitudinal stowage of the swing arm, the deployed and stowed positions of the swing arm may instead lie at 180-degrees to one another, i.e. reaching in opposite positive and negative directions along the Y-axis. Such an example is shown in FIGS. 34 and 35, where the support base 112 is installed in an alternate orientation placing its Y-axis cross-wise to the vehicle and its X-axis longitudinally of the vehicle. In this example, the swing arm 126 lies cross-wise to the vehicle when stowed, thus spanning away from the longitudinal perimeter side of the roof from which the swing arm extends in the deployed position, and reaches toward the opposing longitudinal perimeter side of the roof, In the illustrated example, where the support base is mounted proximate the front driver's side of the vehicle, the stowed swing arm extends toward the opposing passenger side of the vehicle. In the illustrated example of FIGS. 34 and 35, where the support base is mounted near a front corner of the roof, the swing arm is swung forwardly from the stowed position to transition toward the deployed position, thus avoiding an emergency lightbar 200, beacon or other rooftop equipment (not shown) that may reside further back on the rooftop. If the support base is instead mounted near a rear corner of the roof, or at least behind the emergency lightbar 200, beacon or other rooftop equipment, the swing arm would be swung rearwardly from the stowed position to again avoid such conflict with other rooftop equipment of the vehicle. In embodiments where the stowed and deployed positions are at 180-degrees to one another, rather than 90-degrees, the extensions and lock pin holes of the support base and swing arm are relocated accordingly to enable locking in the deployed position.

It will be appreciated that a police cruiser or other vehicle may be equipped with two rooftop safety bars, each installed adjacent a respective side of the vehicle. In embodiments with a 180-degree span between stowed and deployed positions are employed on both sides of a vehicle, offsetting of the support base positions of the two units in the longitudinal direction can be employed to ensure the stowed positions don't interfere with one another. A minimum offset would correspond to the swing arm width of the units, allowing the two swing arms to be stowed in closely neighbouring relation to one another, but this would necessitate movement of one unneeded arm just to allow deployment of the other in instances where the stowed position of the unneeded arm blocks deployment of the other. Mounting of the support bases near diagonally opposite corners of the roof would avoid this, allowing one to be stowed along the front end of the roof, and the other to be stowed along the rear end of the roof, so that the stowed position of one swing arm never interferes with deployment of the other. Another solution would be adapted mounting of the two support bases at different elevations to provide vertical clearance between the horizontal operating planes of the two swing arms.

Since various modifications can be made in my invention as herein above described, and many apparently widely different embodiments of same made, it is intended that all matter contained in the accompanying specification shall be interpreted as illustrative only and not in a limiting sense.

1. A safety bar apparatus for a vehicle, said apparatus comprising:
a support base;
a swing arm pivotally coupled to the support base for movement of said swing arm between a collapsed position folded up into adjacency with a side said support base, and a deployed position spanning outwardly from said side of the support base;
one or more vehicle mounts mounted or mountable on said vehicle to carry said support base thereon in a working position from which the swing arm will span laterally out from a side of the vehicle in the deployed position;
further characterized by at least one of the following features:
(a) the support base and the one or more vehicle mounts are configured to be adjustable in relative position to one another;
(b) the support base is equipped with one or more mounting features at a mounting side of the support base, and the swing arm is positioned to reside adjacent to, and span outward from, a different side of the support base in the collapsed and deployed positions, respectively, and said different side of the support base being of non-opposing relation to said mounting side of the support base; and/or
(c) the support base and the one or more vehicle mounts are configured such that a weight of the support base biases the support base into mated engagement with the one or more vehicle mounts.

2. The apparatus of claim 1 characterized by inclusion of feature (a).

3. The apparatus of claim 1 characterized by inclusion of feature (b).

4. The apparatus of claim 1 characterized by inclusion of feature (c).

5. The apparatus of claim 2 wherein the support base is of an elongated shape having a longitudinal direction along which the one or more vehicle mounts are relocatable to adjust said relative position.

6. The apparatus of claim 2 wherein the one or more vehicle mounts are slidably mated or matable with the support base for sliding movement relative thereto.

7. The apparatus of claim 2 wherein each vehicle mount comprises a collar shaped to span circumferentially around the support base in an installed position thereon.

8. The apparatus of claim 7 wherein the support base and the collar are cooperatively configured to prevent relative circumferential rotation of the collar around the support base in the installed position.

9. The apparatus of claim 2 wherein the support base is slidable back and forth relative to the one or more vehicle mounts to adjust the relative position therebetween, and the support base comprises a stop feature thereon limits sliding thereof relative to said one or more vehicle mounts in a respective direction.

10. The apparatus of claim 9 comprising a linear actuator coupled between the support base and the swing arm to effect movement thereof between the collapsed and deployed positions, and the actuator connects to said support base at a location thereon between said stop feature and a pivot point of said swing arm.

11. The apparatus of claim 9 wherein the stop feature comprises a shoulder defined between a wider portion of the support base, and a narrower portion of the support base that slidably mated with the one or more support mounts.

12. The apparatus of claim 2 wherein the one or more vehicle mounts comprise a pair of separate vehicle mounts configured for separate and independent mounting thereof to the vehicle according to available mounting areas on different vehicles types or models.

13. The apparatus of claim 4 wherein the one or more vehicle mounts define a longitudinal axis along which the support base is slidable while in mated engagement with said one or more mounts, and said one or more mounts are mounted or mountable on said vehicle in positions placing said longitudinal axis in an upright orientation, and said support base has a stop feature thereon for limiting downward travel of said support base relative to said one or more vehicle mounts.

14. The apparatus of claim 1 wherein the support base comprises a length of rectangular tubing.

15. The apparatus of claim 14 wherein each vehicle mount comprises a shorter length of rectangular tubing of greater cross-sectional size that closes around the rectangular tubing of the support base and accommodates sliding receipt thereof in the shorter length of rectangular tubing.

16. The apparatus of claim 1 installed on a vehicle, wherein the support base is installed in positions placing the swing arm in a downwardly hanging orientation in the collapsed position.

17. The apparatus of any one of claims 1 to 18 installed on a vehicle at a location thereon situated in, at or adjacent a gap space left between, or a transitional area joining together, a driver cabin of said vehicle and a rear working section of said vehicle.

18. The apparatus of claim 17 installed on a rear wall of said driver cabin, or a front wall of said rear working section of the vehicle.

19. In combination, a vehicle and a safety bar apparatus installed thereon, said safety bar apparatus comprising a swing arm pivotally movable on a support base between a collapsed position of zero or minimal protrusive relation from the vehicle, and a deployed position spanning laterally outward from a side of the vehicle to visually warn oncoming traffic of the potential presence of one or more personnel working at or proximate said vehicle, wherein the swing arm is supported on the vehicle by one or more vehicle mounts affixed to the vehicle, and the support base is securable to said one or more vehicle mounts in a plurality of different positions relative thereto to enable repositioning of the swing arm relative to the vehicle.

20. A safety bar apparatus for a vehicle, said apparatus comprising:
a roof-mountable support base configured for mounting to a roof of said vehicle; and
a swing arm pivotally coupled to the support base for pivotal movement of said swing arm relative to said roof-mountable support base about an upright pivot axis between a stowed position projecting laterally from said pivot axis in a first direction so as to span laterally outward from the roof of the vehicle, and a deployed position projecting laterally outward from said pivot axis in a different second direction so as to overlie the roof of the vehicle between opposing longitudinal perimeter edges thereof.
